(19) United States
(12) Patent Application Publication
(10) Pub. No.: US 2013/0321225 A1
(43) Pub. Date: Dec. 5, 2013

(54) AUTOMATIC ANTENNA POINTING AND STABILIZATION AND METHOD THEREOF

(71) Applicant: VUBIQ INCORPORATED, Aliso Viejo, CA (US)

(72) Inventor: Michael Gregory PETTUS, Laguna Niguel, CA (US)

(21) Appl. No.: 13/909,033

(22) Filed: Jun. 3, 2013

Related U.S. Application Data
(60) Provisional application No. 61/654,701, filed on Jun. 1, 2012.

(51) Int. Cl. H01Q 3/08

(52) U.S. Cl. CPC H01Q 3/08
USPC 343/765

(57) ABSTRACT

A wireless backhaul system including a terminal is disclosed. The system includes a network interface that is configured to send and receive data over a wide area network. A control module is coupled to the network interface and configured to generate electromagnetic energy. An antenna assembly is coupled to the control module and the network interface. The antenna assembly includes a high speed-high bandwidth (HSHB) antenna configured to wirelessly emit millimeter wave electromagnetic energy signals to a target terminal. A gimbal assembly is coupled to the antenna assembly and the control module. The gimbal assembly is configured to selectively position the antenna assembly to azimuth and elevation coordinates selected by the control module to establish and maintain a HSHB data communication link with the target terminal using the millimeter wave electromagnetic energy signals.

### RELATED APPLICATION

The present application claims priority to co-pending U.S. Provisional Patent Application Serial. No. 61/654,701, filed on Jun. 1, 2012, which is hereby incorporated by reference in its entirety.

### FIELD

The present disclosure relates generally to an automatic antenna pointing and stabilization system and method thereof.

### BACKGROUND

Microwave and millimeter wave (generally those radio frequency bands greater than 30 GHz) are experiencing an upward surge in growth for connections between locations where cable or fiber are impractical to implement. Trenching and reconstruction in order to lay and route a cable or fiber is especially expensive and difficult in the metropolitan cities around the world. The natural alternative is to use a wireless solution that can provide voice and data connectivity between desired locations. The largest potential growth for wireless link technology is in the area of infrastructure support for the global mobile telecommunications systems.

The mobile communications services now being offered for 4G/LTE generation products are providing unprecedented bandwidth to the mobile end user. Smart phones and wireless enabled tablets now use bandwidths exceeding 10 Mb/s and are evolving to over 100 Mb/s as consumer applications such as internet access, video streaming and text communications overtake traditional voice traffic. Mobile base stations or cellular towers designed for earlier generation networks (such as 2G and 3G) were spaced at 3 to 5 km apart in the dense urban usage areas. The 4G/LTE cell site spacing is expected to decrease down to the 300 to 500 meter range with the concomitant number of sites increasing by an order of magnitude. The shorter distance and increase in cell site number is necessary to support the higher bandwidths and higher capacities. The increase in the number of mobile users with high bandwidth applications gives rise to an exponential increase in the required infrastructure system capacity. These new cell sites are smaller, cheaper and lighter than their earlier predecessors. The new cell site technologies have been dubbed various names from “microcell” to “picocell” and now are generally referred to as “small cell” topologies. In particular, the latest technologies are being applied into the radio access networks (RAN) as LTE Advanced as defined by the global 3^{rd} Generation Partnership Project (3GPP). LTE Advanced is driving the user element (UE), or mobile terminal data rates up to 1 Gbps.

The older cell sites were generally deployed on large towers requiring moderate bandwidths designed to support voice-only traffic. The typical bandwidth required for the connection from the cell site back to the mobile switching office was on the order of tens of megabits. This connection, called the backhaul link, was usually implemented with T-carrier lines and would support in aggregated capacity from a few Mb/s up to 20 Mb/s as needed. As the fiber infrastructure grew, some of the tower locations could be interconnected directly to fiber which would support much higher bandwidths. But most of the cell towers were not located at fiber drops, and higher bandwidths were required during the growth of mobile users in both number and data rates. The logical alternative was to use microwave wireless for backhaul that could support up through 50 Mb/s. These microwave backhaul technologies are based on digital radio design and use licensed radio spectrum in the 2 to 40 GHz range.

As demand for bandwidth grew, higher order modulation and more spectrally efficient radios were designed and started to push the limits of physics in attempts to grow above 100 Mb/s for these links. The fundamental constraint for microwave backhaul is the limited spectrum in these frequency ranges. Early channel bandwidths were based on older voice traffic systems and were on the order of kHz wide. Pressure on these channels yielded new spectrum allocations and channels were increased to several MHz, but the lack of physical radio spectrum in the crowded bands below 40 GHz was the ultimate limit on system capacity. New spectrum has recently been allocated in the higher frequency bands above 40 GHz. These bands, called millimeter wave due to the shorter wavelengths associated with the higher frequencies, are now set in place at 60 GHz and 70/80 GHz worldwide. There is about 7 GHz of bandwidth available in the 60 GHz band and 10 GHz in the 70/80 GHz bands. Compared with the lower frequencies, these bandwidths are much greater and can support much higher bit rates and capacities.

Recently, silicon technologies (SiGe and CMOS) have been introduced which now support the ability to achieve low-cost radio technologies in the millimeter wave bands. As a result, the anticipated growth in millimeter wave backhaul radios with associated bandwidths in the GHz range, supporting greater than Gb/s data rates, is expected to significantly outpace traditional microwave radios.

In order to achieve the necessary range and capacity using millimeter wave radios, high gain antennas are required that enable longer distances and narrower beamwidths. With narrow beamwidths, more backhaul links can be installed in a given area due to the ability to place the links physically closer together. This ability, called spatial reuse, enables extremely high area capacities for the small cell and high density 4G/LTE networks of the future. High capacity, Gb/s links will be installed at small cells providing the necessary wireless backhaul from locations such as street light poles, utility poles, buildings and road signs to name a few. The traditional larger cell tower (now dubbed as the “macrocell”) will remain in place but will change in function to become network hubs for traffic emanating from the small cells.

Existing millimeter wave and microwave link technology is designed to be mounted on a tower, pole or building site with the requirement that the radio and/or its antenna be precisely pointed to the other end of the link. Each end of the radio link employs highly directional antennas with beamwidths decreasing down to less than one degree in order to achieve the required range and to reduce interference with other links in the same area. The installation personnel are required to adjust and point the radio using either signal strength indication and/or optical pointing methods such as the use of accessory high-powered sighting scopes. The personnel must be trained for this kind of precision installation and the use of specialized equipment and installation tools.

Note that use of various tools may be required to loosen, adjust, sight, and then tighten each axis of an azimuth/elevation type mounting bracket for the terminal installation. The sighting scope is typically installed on the terminal and then removed once the terminal is aligned. Also, if the building, pole or tower on which the terminal is mounted moves due to vibration, swaying or other factors, either dynamically or permanently, the positioning will not hold and the link will go off the air requiring realignment. More importantly from an economic perspective, this type of link failure requires a revisit by installation personnel, known in the industry as a “truck roll” and results in undesirable additional costs.

What is needed is an automatic antenna pointing and stabilization system and method thereof.

### SUMMARY

In an aspect, a wireless backhaul system including a terminal is disclosed. The system includes a network interface that is configured to send and receive data over a wide area network. A control module is coupled to the network interface and configured to generate electromagnetic energy. An antenna assembly is coupled to the control module and the network interface. The antenna assembly includes a high speed-high bandwidth (HSHB) antenna configured to wirelessly emit millimeter wave electromagnetic energy signals to a target terminal. A gimbal assembly is coupled to the antenna assembly and the control module. The gimbal assembly is configured to selectively position the antenna assembly to azimuth and elevation coordinates selected by the control module to establish and maintain a HSHB data communication link with the target terminal using the millimeter wave electromagnetic energy signals.

In an aspect, the system includes a target terminal which includes a network interface configured to send and receive data over the wide area network; a control module coupled to the network interface and configured to generate electromagnetic energy; an antenna assembly coupled to the control module and the network interface, the antenna assembly including a high speed-high bandwidth (HSHB) antenna configured to wirelessly emit millimeter wave electromagnetic energy signals to the terminal; a gimbal assembly coupled to the antenna assembly and the control module, the gimbal assembly configured to selectively position the antenna assembly to azimuth and elevation coordinates selected by the control module to establish and maintain a HSHB data communication link with the terminal using the millimeter wave electromagnetic energy signals.

In an aspect, the local and/or target terminals further comprise a base configured to receive the gimbal assembly; a radome lid coupled to the base and configured to form an enclosure between the radome lid and the base, wherein the gimbal and antenna assemblies are positioned within the enclosure. In an aspect, the local and/or target terminals are configured to be secured to a fixture.

In an aspect, the antenna assembly further comprises a low speed-low bandwidth (LSLB) antenna coupled to the control module, the antenna oriented coaxially with the HSHB antenna and configured to emit microwave signals; a printed circuit board having one or more circuits including the control module, the printed circuit board configured to couple to the LSLB antenna and the HSHB antenna, the control module configured to wherein the control module selects the HSHB antenna to communicate the data with the target terminal using a millimeter wave connection link, and wherein the control module selects the LSLB antenna to communicate the data with the target terminal using a microwave connection link.

In an aspect, the control module further comprises a positioning module configured to measure rotational and translational movement in the x, y, and z directions. In an aspect, the positioning module includes a global navigation system configured to provide latitude, longitude and elevation data regarding the terminal.

In an aspect, the gimbal assembly further comprises: an antenna bracket configured to couple with the antenna assembly; a U-shaped bracket mount coupled to the antenna bracket and a base of a terminal housing: a first gear assembly coupled to antenna bracket and the bracket mount, the first gear assembly configured to allow rotation of the antenna bracket along an elevation axis; and a second gear assembly coupled to the bracket mount, the second gear assembly configured to allow rotation of the gimbal assembly in an azimuth axis.

In an aspect, a method of establishing a high speed-high speed (HSHB) connection is disclosed. The method comprises identifying, at a local backhaul terminal, position coordinate information of a target backhaul terminal, the local backhaul terminal having a high speed-high bandwidth (HSHB) antenna configured to wirelessly emit millimeter wave electromagnetic energy signals to the target terminal; calculating a position vector to point the HSHB antenna to a corresponding HSHB antenna of the target terminal to establish a HSHB data communication link therebetween, the position vector including selected azimuth and elevation coordinates; and automatically adjusting the HSHB antenna to be pointing to the calculated position vector to maintain the HSHB data communication link with the target terminal.

In an aspect, the method includes establishing a low speed-low bandwidth (LSLB) configured to wirelessly emit microwave electromagnetic energy signals to the target terminal, wherein the position coordinate information of the target backhaul terminal is identified at the local backhaul terminal via a LSLB connection link.

In an aspect, the method includes the HSHB antenna further comprises: operating a first motor to rotate the HSHB antenna about an elevation axis; and operating a second motor to rotate the HSHB antenna about an azimuth axis.

In an aspect, the method includes determining position coordinate information of the local backhaul terminal and exchanging the position coordinate information with the target backhaul terminal.

In an aspect, the method includes monitoring a bit error rate (BER) of the HSHB communication link with the target backhaul terminal; and adjusting the HSHB antenna to be pointing to the calculated position vector to achieve a higher BER rate over the HSHB data communication link with the target terminal.

In an aspect, the method includes determining the HSHB data communication link has failed between the local backhaul terminal and the target backhaul terminal; and switching data communications with the target backhaul terminal over a low speed-low bandwidth (LSLB) microwave communication link.

In an aspect, a wireless backhaul terminal includes a network interface configured to send and receive data over a wide area network; a control module coupled to the network interface and configured to generate electromagnetic energy; an antenna assembly including a high speed-high bandwidth (HSHB) antenna coupled to the control module, the HSHB antenna configured to wirelessly emit millimeter wave electromagnetic energy signals to a target terminal and a low speed-low bandwidth (LSLB) antenna coupled to the control module, the LSLB antenna configured to wirelessly emit microwave signals to the target terminal, wherein the control module selects the HSHB antenna to communicate the data with the target terminal using a millimeter wave connection link, and wherein the control module selects the LSLB antenna to communicate the data with the target terminal using a microwave connection link.

In an aspect, the terminal includes a gimbal assembly coupled to the antenna assembly and the control module, the gimbal assembly configured to selectively position the antenna assembly to azimuth and elevation coordinates selected by the control module to establish and maintain a HSHB data communication link with the target terminal using the millimeter wave electromagnetic energy signals.

In an aspect, the terminal includes a base configured to receive the gimbal assembly; a radome lid coupled to the base and configured to form an enclosure between the radome lid and the base, wherein the gimbal and antenna assemblies are positioned within the enclosure.

In an aspect, the control module further comprises a positioning module configured to measure rotational and translational movement in the x, y, and z directions.

In an aspect, the positioning module includes a global navigation system configured to provide latitude, longitude and elevation data regarding the terminal.

In an aspect, the gimbal assembly further comprises an antenna bracket configured to couple with the antenna assembly; a U-shaped bracket mount coupled to the antenna bracket and a base of a terminal housing: a first gear assembly coupled to antenna bracket and the bracket mount, the first gear assembly configured to allow rotation of the antenna bracket along an elevation axis; and a second gear assembly coupled to the bracket mount, the second gear assembly configured to allow rotation of the gimbal assembly in an azimuth axis.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 illustrates a block diagram illustrating the components of a plurality of terminals in accordance with an aspect of the present disclosure;

FIG. 2A illustrates a flow chart representing establishing a high speed/high bandwidth communication link between terminals in accordance with an aspect of the present disclosure;

FIG. 2B illustrates an operational flow chart of backup operation performed by the terminal during a high speed/high bandwidth failover event;

FIGS. 3A and 3B illustrate right side up and upside down views of an example terminal in accordance with an aspect of the present disclosure;

FIG. 3C illustrates an exploded view of an example terminal in accordance with an aspect of the present disclosure;

FIG. 4 illustrates an exploded view of an exemplary antenna assembly in accordance with an aspect of the present disclosure;

FIG. 5A illustrates a non exploded view and FIG. 5B illustrates an exploded view of the gimbal assembly in accordance with an aspect of the present disclosure;

FIGS. 5C-5E illustrate various views of a gear assembly in accordance with an aspect of the present disclosure;

FIGS. 6A and 6B illustrate various views of the terminal and in particular the azimuth and elevation axes in accordance with an aspect of the present disclosure;

FIGS. 7A-7I illustrate various examples of how elevation positions of the antenna/gimbal assembly are determined in accordance with an aspect of the present disclosure;

FIG. 8A-8G illustrate various examples of how azimuth positions of the antenna/gimbal assembly are determined in accordance with an aspect of the present disclosure; and

FIG. 9 illustrates a flow chart representing how elevation and azimuth positions are determined and implemented in the terminal in accordance with an aspect of the present disclosure.

### DESCRIPTION OF EXAMPLE EMBODIMENTS

Example embodiments are described herein in the context of an automated antenna pointing and stabilization system and method thereof. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

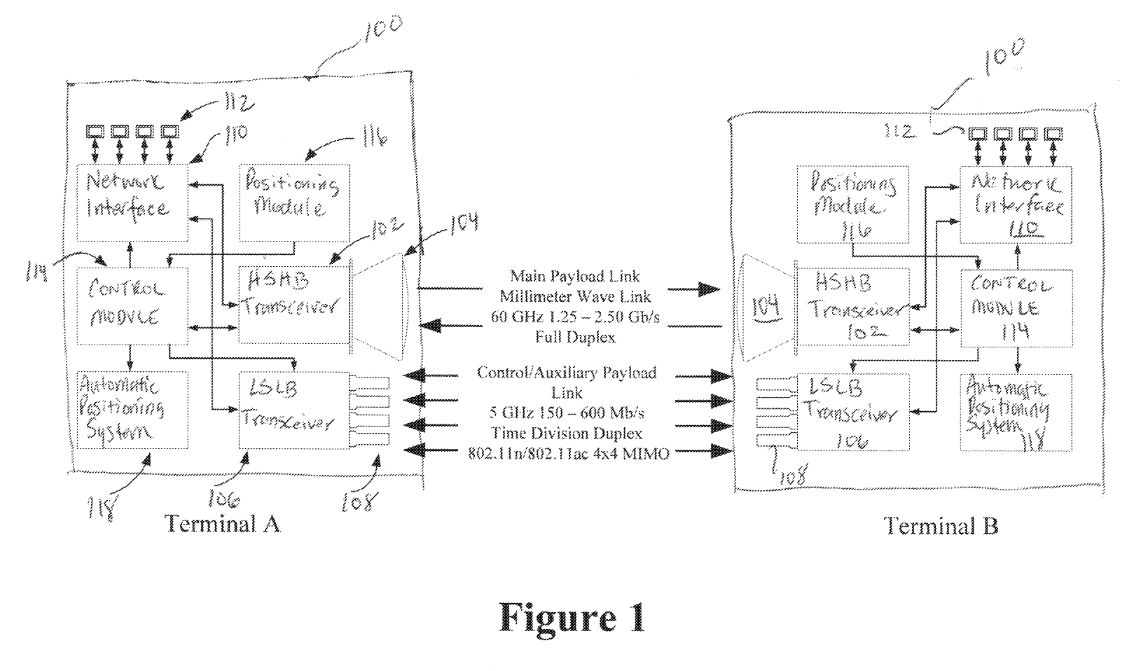

FIG. 1 illustrates a block diagram illustrating the components of a plurality of terminals in accordance with an aspect of the present disclosure. As shown in FIG. 1, one or more of the terminals 100 includes a high speed/high bandwidth (HSHB) transceiver 102, one or more HSHB directional antennas 104, a low speed/low bandwidth (LSLB) transceiver 106, one or more low bandwidth antennas 108, a network interface 110 (e.g. Ethernet switch) having one or more physical wired or wireless interface ports 112, a control module 114, a position module 116, and an automatic positioning system 118. As shown in FIG. 1, each of components are coupled to one another and some components shown in different blocks may be combined together in on block. For instance, the control module 114 may include the position module 116 and automatic positioning system 118. It should be noted that although each of the terminal devices 100 are shown in FIG. 1 to include the same components, it is contemplated that the terminals need not have the same components. For instance, one (or both) of the terminals need not have an automatic positioning system 118.

The HSHB directional antenna 104 and transceiver 102 allow data communications over a high bandwidth frequency, such as the 60 GHz frequency spectrum. It should be noted, however, that other frequency bands are contemplated, such as, but not limited to 70/80 GHz, 90 GHz, 120 GHz, 240 GHz or higher. Note that the same methods can be used at lower microwave frequencies in addition, as long as a directional type antenna is used.

The HSHB transceiver module 102 allows the terminal 100 to form a point-to-point radio link with one or more other terminals 100 in which the radio link operates in frequency division full duplex communications mode. Other communications modes and link topologies are anticipated such as but not limited to frequency division half-duplex, time division duplex, or simplex modes. In addition, various point-to-multipoint topologies, mesh topologies and repeating mesh topologies are contemplated. Details of the HSHB transceiver 102 and its capabilities are discussed in U.S. patent application Ser. No. 13/383,203, Filed Jan. 19, 2012 and entitled, “Precision Waveguide Interface.”

The LSLB transceiver 106 is configured as a microwave control/telemetry transceiver such as a 5 GHz transceiver with an associated set of one or more broad beamwidth antennas 108. The LSLB transceiver 106 can use, but is not limited to, various IEEE 802.11 wireless protocols such as 802.11n or 802.11ac. In an aspect, the antenna beamwidth used for a low speed/bandwidth antenna 108 operating at the 5 GHz range includes or is greater than 40 degrees. In an embodiment, the LSLB transceiver 106 and antenna 108 use multiple-input multiple-output (MIMO) and other smart antenna technologies. It should be noted that, in an aspect, the LSLB transceiver 106 uses four LSLB antennas 108 to provide spatial and polarization diversity which can operate in conjunction with the MIMO technology.

The network interface 110 comprises one or more mechanisms that enable the terminal 100 to engage in TCP/IP communications or other communications over a local area and/or wide area network. However, it is contemplated that the network interface 110 may be constructed for use with other communication protocols and types of networks. Network interface 110 is sometimes referred to as a transceiver, transceiving device, or network interface card (NIC), which transmits and receives network data packets over one or more networks. As shown in FIG. 1, the network interface 110 is coupled to one or more physical interface ports 112. In an aspect, the interface port 112 is configured to receive Ethernet cables or optical fibers to allow data transfer over a wired connection, although it is contemplated that the interface port 112 can be an antenna configured to allow data transfer over a wireless connection. Data communicated to and from the terminal is sent to a wide area network, via WiFi, WiMax and/or mobile cell towers via the network interface 110.

The control module 114 is configured to provide and execute control, monitoring and modulation processes employed by the terminal 100. The control module 114 resides on the printed circuit board along with the duplexer module and waveguide modules, which are discussed in more detail below. The control module 114 includes one or more processors and one or more memories coupled to the one or more processors. The one or more microprocessors are configured to execute computer/machine readable and executable instructions stored in the respective local or remote device memory. Such instructions are executed by the processor to perform one or more functions described below. It is understood that the processor may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The memory incorporated in the control module comprises non-transitory computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by the one or more processors. Examples of computer readable storage media include RAM, BIOS, ROM, EEPROM, flash memory, firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

In general, the positioning module 116 handles all positioning information associated with the terminal. Such positioning information may relate to positioning information of the terminal itself or other terminals (e.g. global positioning data, movement data) and/or positioning information of internal components of the terminal (e.g. elevation, azimuth, calibration data). In an aspect, the positioning module 116 includes a Global Navigation Satellite System (GNSS) receiver which acquires signals from one or more global positioning satellites to allow the terminal to determine its longitude and latitude coordinates. In an aspect, the positioning module 116 allows the terminal 100 to determine altitude information of the terminal 100 itself and/or the surrounding terrain. For example, the terminal 100, via the positioning module 116, may be able to determine its overall altitude (e.g. 12,020 ft above sea level) as well as altitude of the overall terrain (e.g. 12,000 ft. above seal level). In an aspect, the positioning module 116 includes a multi-axis accelerometer, a multi-axis gyroscope and multi-axis compass to allow the terminal to monitor position of the gimbal assembly as well as overall movement of the terminal 100 itself, as described in more detail below.

The automatic positioning system 118 is a mechanically adjustable system comprising motors and gear systems which are configured to operate with the other components of the terminal to allow automatic mechanical movement the HSHB antenna 104 and the LSLB antenna 108 to desired rotation, elevation and azimuth position coordinates to establish high speed/bandwidth and low speed/bandwidth communication links with one or more target terminals 100. Details of the automatic positioning system 118 are described below.

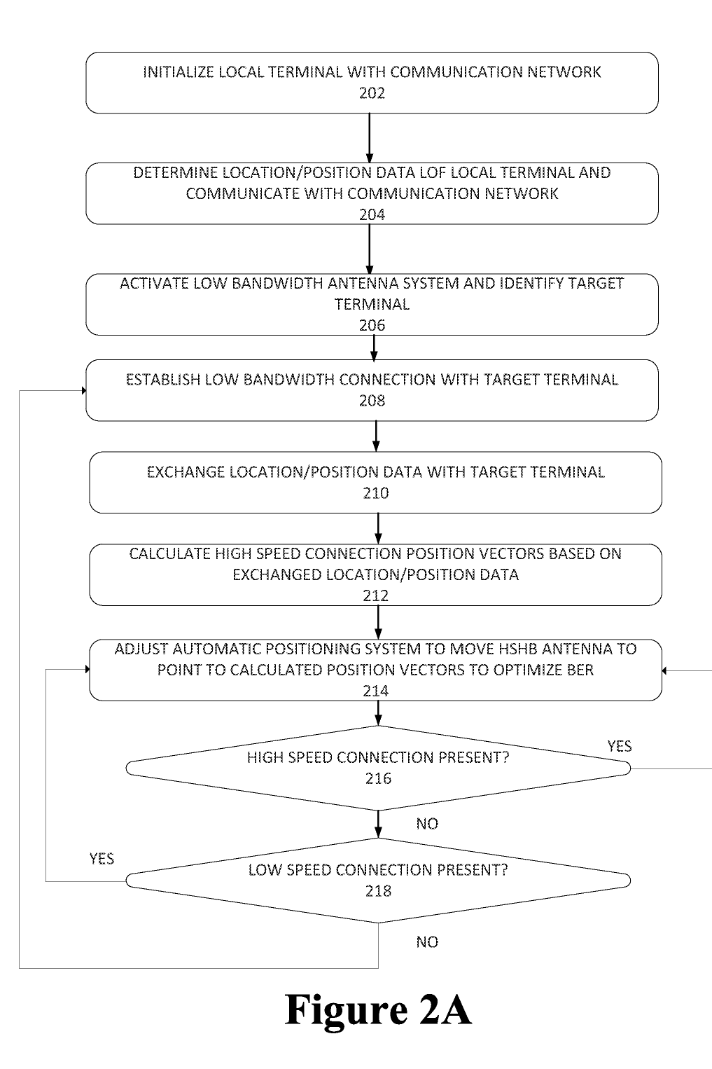

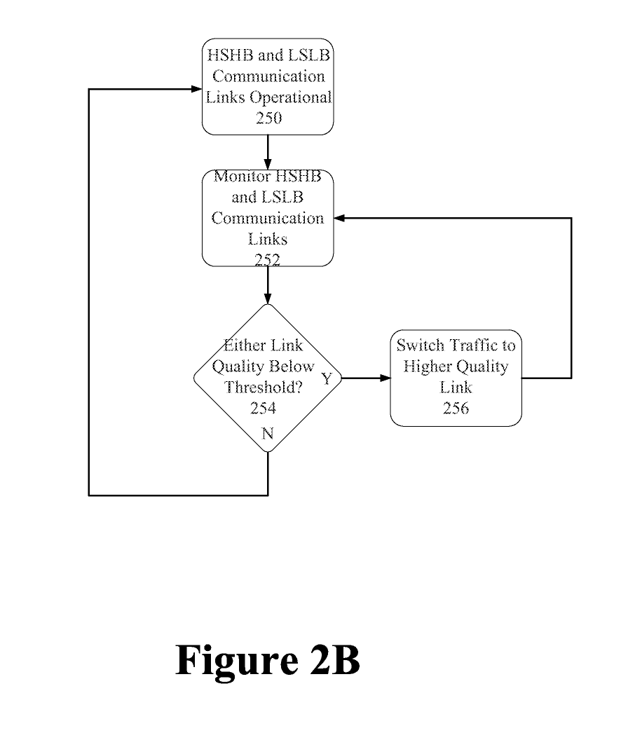

FIG. 2A illustrates a flow chart representing establishing a high speed/high bandwidth communication link between terminals in accordance with an aspect of the present disclosure. As shown in the flow chart 200, after at least two terminals 100 are installed, initialization occurs at power up of the terminals at each end of the link, wherein each terminal communicates with a wide area network (i.e. Internet), a dedicated telecommunications network, or an endpoint device on a telecommunications network such as a cellular base station via the network interface 110 (Block 202). As shown in the flow chart 200, after at least two terminals 100 are installed, initialization occurs at power up of the terminals at each end of the link, wherein each terminal communicates with a wide area network (i.e. Internet) via the network interface 110 (Block 202). Each terminal 100 then determines their location and position coordinate data using the GNSS module 116 (Block 204). As stated above, each terminal 100 is able to identify where it is located geographically and communicates such information to one or more servers in a server network which monitor such data. In an aspect, the terminal 100 may receive, from the server network, data identifying other terminals located within a desired range from the terminal 100.

The terminal 100 then activates the low-frequency/bandwidth transceiver module 106 and antenna(s) 108 to achieve communications with each other and establish a logical link between the terminals 100 (Block 206). The local terminal 100 then establishes a low bandwidth connection with the target terminal 100 (Block 208). It is not necessary at the initialization stage for the gimbal assemblies of each of the terminals 100 to be pointing at each other since the low-frequency radio beam patterns emitting from antenna 108 are broad enough to enable point-to-point communications without consideration of initial gimbal pointing angles. Along with the exchange of terminal identification and system configuration information, GNSS positional data and specific positioning module 116 data, such as current compass headings, are also exchanged between the local terminal and the target terminal (Block 210).

Using the positional GNSS information received from the target terminal 100, the processor of the local terminal 100 is able to calculate position vector data (e.g. bearing and distance data) to establish a high speed/high bandwidth connection between the local terminal's physical location to the target terminal's location (Block 212). In particular, the control module 114 receives remote terminal ID and location information of the target terminal via the LSLB transceiver 106 during initialization. The control module 114 performs the distance and bearing calculations required to determine the azimuth and elevation angles for appropriate HSHB terminal-to-terminal, or link alignment.

The local terminal 100 thereafter operates the gimbal assembly to move the high bandwidth antenna 104 to the calculated position vector (Block 214). In particular, the orientation of the gimbal assembly at the local terminal is locally sensed by sensors (e.g. multi-axis accelerometer, multi-axis compass) of the terminal 100. The processor of the control module 114 performs the calculations based on the known physical orientation and the desired bearing to the target terminal 100 to determine the azimuth and elevation angles at which the high bandwidth antenna 104 is to point in the correct orientation towards the target terminal 100. The processor of the control module 114 then controls the azimuth and elevation motors to appropriately position the gimbal assembly to the correct orientation to aim the high bandwidth antenna 104 towards the corresponding high bandwidth antenna 104 of the target terminal 100. This process repeats, as shown in Block 216, until the high speed/bandwidth connection is established between the local and target terminals 100. In the event that the low speed connection is lost between the local and target terminals 100, the process repeats to Block 208.

In an aspect, once the HSHB antennas 104 of the local and target terminals 100 are aligned and have enabled communications over the high-bandwidth millimeter wave link, the received signal strength indication (RSSI) and the received bit error rate (BER) are used to precisely adjust the azimuth and elevation motors in order to bring the antennas 104 into their exact positions to achieve the highest performance over the high bandwidth link. The highest performance operation of the link is defined as the minimum BER and will typically occur with an associated highest RSSI measurement. In some cases, however, the BER and RSSI measurement data may not correlate due to propagation anomalies that cause inter-symbol distortion due to path diffraction and/or multipath fading. The algorithm executed by the processor of terminal's 100 control module 114 uses both receiver measurement parameters of RSSI and BER to precisely adjust the gimbal headings and may defer to BER as the final arbiter of maximum performance.

Once the high-frequency millimeter wave link is established through this process, the fine adjustments are made to the azimuth and elevation motors by sensing the RSSI and BER from the high-frequency millimeter wave receiver at each terminal. In particular where stabilization is required, the control processor continuously monitors data from the sensors to identify any changes in translational motion (from the multi-axis accelerometer) and rotational motion (from the multi-axis gyroscope). Orientation correlation with the dynamic sensors is also monitored from the multi-axis compass. If any changes from these sensors that can affect normal link operation due to misalignment of the HSHB communication link, the processor of control module 114 outputs signals to the azimuth and/or elevation motors as needed to compensate for any changes in the HSHB position vector data in order to maintain the HSHB communication link quality. RSSI and BER are used as fine adjustment on a dynamic basis to augment the positioning module 116.

In an aspect, once the terminals at each end of the link have positioned their respective gimbals, the azimuth and elevation axes are no longer moved and the gimbal assemblies are effectively locked into their positions. There can be optional operational features added such as not only initial terminal antenna pointing but also maintenance of the gimbal's azimuth and elevation positions during dynamic anomalies which may cause the position of the terminal enclosure to move. These anomalies can be created by the swaying of a pole, building or tower during high winds, or vibration/movement of the mounting location caused by other reasons such as earthquakes, accidental collisions near the terminal location, or animal/foul physical interference to the terminal mounting location. If, for example, a pole sways in the elevation plane, the effective elevation angle of the millimeter wave antenna will vary to the extent that it can lose the high-bandwidth link as the sway angle moves the antenna beyond the beamwidth angle. The detection of this kind of movement makes use of the multi-axis gyroscope and multi-axis accelerometer in the positioning module 116. Once either rotational or translational movement, or both, is detected, the processor calculates the angular movement necessary to supply the azimuth and elevation motors on the gimbal to maintain the correct antenna orientation. The RSSI and BER are used in conjunction with the gimbal corrections to finely adjust the gimbal for maintenance of the signal from the receiver. Note that dynamic gimbal maintenance can occur at both ends of the link in order to maintain signal quality. In an aspect, the terminals can also use the auto-alignment and stabilization to maintain antenna alignment for a continuously moving terminal, as in a moving vehicle or high-speed train.

FIG. 2B illustrates an operational flow chart of backup operation performed by the terminal during a high speed/high bandwidth failover event. During certain conditions, millimeter wave propagation can be attenuated (e.g. heavy rainfall, temporary blockage condition by moving foliage, large birds) which affect millimeter wave propagation but may not affect lower frequency propagation. As shown in FIG. 2C, the normal operation of the terminal occurs where the terminal is successfully operating both the HSHB connection link and the LSLB connection link (Block 252). In addition, the terminal 100 will monitor movement data as well as operational condition data of both communication links to determine if a lower threshold of the RSSI signal or complete loss of signal has been detected at the terminal (Block 254). The processor of the terminal will then switch the data connection that is normally connected to the HSHB transceiver to the LSLB transceiver as a method of providing link backup during blockage conditions (Block 256). The lower frequency link communications that is then established will typically provide a more robust level of communications although without the benefit of high bandwidth and low interference that the HSHB communication link exhibits. Once the terminal again detects an RSSI signal with low BER, the terminal 100 reestablishes the HSHB connection link with the target terminal and normal operation is restored.

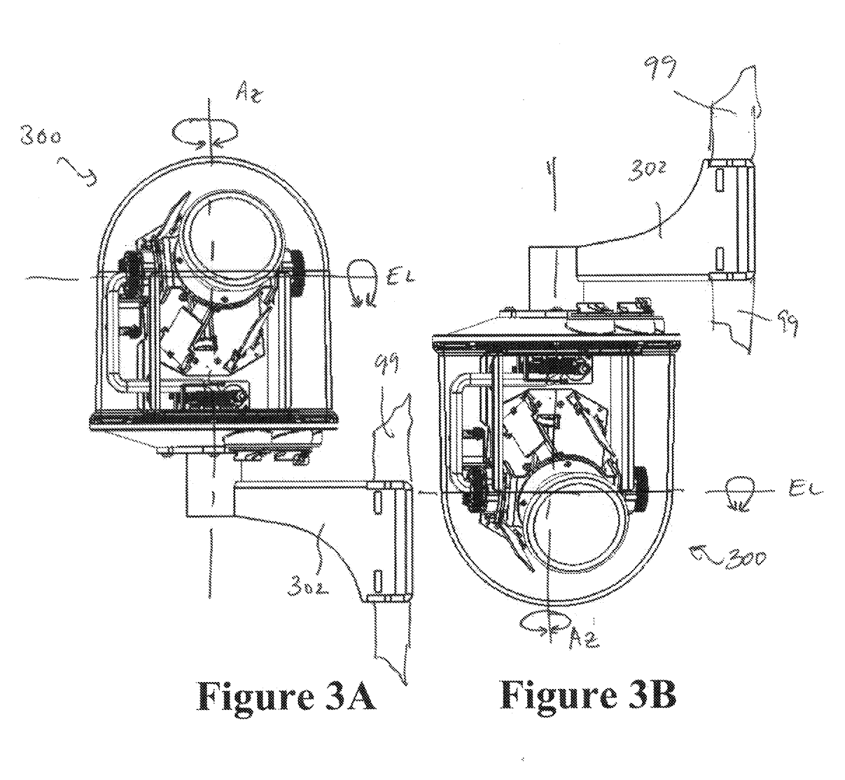

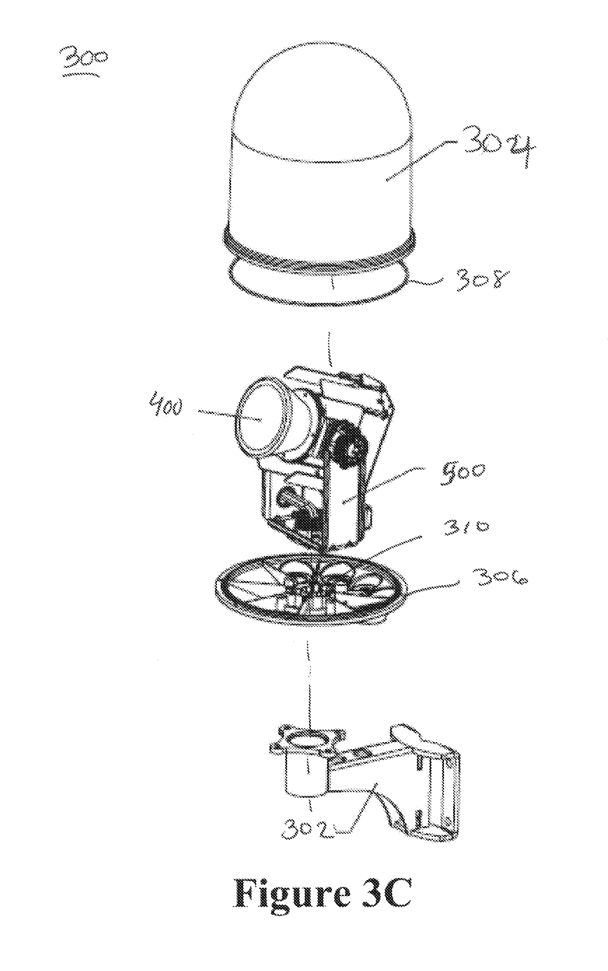

FIGS. 3A and 3B illustrate right side up and upside down views of an example terminal in accordance with an aspect of the present disclosure. As shown in FIG. 3A, the terminal 300 (represented as 100 in FIG. 1) is configured to removably mount to a bracket 302, in which the bracket 302 is removably mountable on a commercial, residential or industrial fixture. In an aspect, the bracket 302 and terminal 300 are configured to allow the terminal right side up (FIG. 3A) or upside down (FIG. 3B). It is contemplated that the terminal 100 be oriented at an angle between the right side up and upside down orientations shown in FIGS. 3A and 3B. This allows the terminal 300 to be mounted in any orientation to buildings, homes, subways, poles, road signs, radio towers, street lights and the like. In an aspect, the terminal 100 can be mounted inside a building near a window such that radio transmission to and from other terminal(s) propagates through the window. It should be noted that, although most of the discussion relates to a point-to-point link (i.e. terminal A to terminal B), point to multipoint, mesh, and repeating mesh topologies, and other link topologies are contemplated. For example, it is contemplated that the terminals 100 may be configured for point-to-point communications configured with a plurality of redundant terminals either co-located with the terminal endpoints or spatially diverse for network re-organizing abilities.

FIG. 3C illustrates an exploded view of an example terminal in accordance with an aspect of the present disclosure. As shown in FIG. 3C, the terminal 300 includes a radome lid 304, a base portion 306, an antenna assembly 400 and a gimbal assembly 500. In an aspect, the base 306 is coupled to the bracket 302, and the combined antenna and gimbal assembly 400, 500, along with the lid 304, is coupled to the base 306. A sealing ring 308 is positioned between the lid 304 and the base 306 to ensure a hermetically sealed enclosure within the terminal 300. As will be discussed in more detail below, a flange of a gear assembly coupled to the gimbal assembly is mounted to interface 310 of the base 306.

The radome lid 304 is made of a dielectric material as serves as a main protective enclosure when affixed to the base 306. In an example aspect, the radome lid 304 is made of a high-density polyethylene (HDPE) with a thickness of an odd multiple of ½ guide wavelength λ (approximately 4.9 mm at 60 GHz), although other dielectric radome materials and thickness are contemplated.

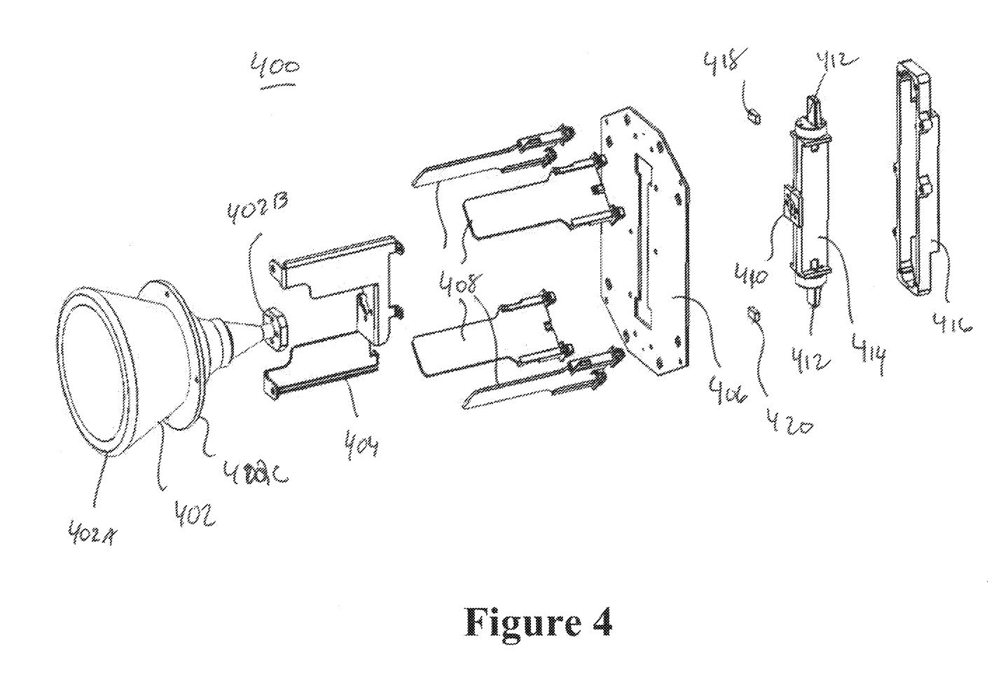

FIG. 4 illustrates an exploded view of an exemplary antenna assembly in accordance with an aspect of the present disclosure. The exemplary antenna assembly 400 shown in FIG. 4 includes a high speed/high bandwidth (HSHB) wave horn antenna 402, a horn bracket 404 having a plurality of low speed/low bandwidth (LSLB) flat dielectric antennas 408, a main printed circuit board (PCB) 406, duplexer filter 414 having a duplexer interface 410, one or more transmit/receive waveguide modules 412 coupled to the ends of the duplexer filter 414 and a board attachment block 416. One or more multi-axis compass, gyroscope and accelerometer chips 418, 420 are coupled to the PCB 406.

The HSHB horn antenna 402 has a front end 402A and a rear interface 402B, wherein the HSHB antenna 402 generally tapers outward from the rear interface 402B to the front end 402A. The front end 402A of the antenna 402 has a circular shape, as shown in the Figures, but is not limited thereto. In an aspect, the horn type antenna 104 is configured to propagate 60 GHz frequency signals provided from the duplexer 414 and waveguide modules 412 via the interface 410. In an aspect, the antenna 104 is configured to provide a gain of 30-40 dBi for frequencies greater than 50 GHz. It should be noted, however, that other gains are contemplated and are not limited to the range discussed. Although the HSHB antenna 402 is shown to have a horn type shape, the antenna may alternatively be configured as a parabola, flat panel array, Yagi-Uda array and the like. In an aspect, the beamwidth implemented by the high speed bandwidth antenna is between and including 1-20 degrees, although other ranges are contemplated.

As shown in FIG. 4, a portion near the rear interface 402B is received within a notch 404A of the horn bracket 404 to support the horn antenna 402. The horn bracket 404 is coupled on a side of the printed circuit board 406 proximal to the antennas. The board attachment block 416 secures the duplexer module 414 to the printed circuit board 406.

In an aspect, one or more low speed-low (LSLB) bandwidth antennas 408 are coupled to the proximal side of the PCB 406 and preferably extend in the same direction as the HSHB antenna 402. In the example in FIG. 4, four LSLB antennas are coupled the PCB 406 at its respective corners, although other placement designs are contemplated.

The LSLB antenna 408 has a flat, rectangular shape that is made of a dielectric material having a high dielectric constant (e.g. 10.2, Rogers material RO3010). The antenna 408 has a dipole driven element that is coupled to a connector. Even though there are no electrical elements beyond the dipole driven element, the dielectric material in front forms a directional beam pattern. The LSLB antennas 408 move together with the HSHB antenna 402 as a single unit in the elevation (EL) and azimuth (AZ) directions by virtue of the gimbal assembly 500, as shown by the arrows in FIGS. 3A and 3B.

The duplexer includes a standard 3-port filter, with the antenna port at the center and is commonly coupled to the high frequency and low frequency ports. The antenna provides transmission and reception simultaneously and the duplexer acts as a highly selective filter such that the transmitted energy is coupled from the transmitter port to the antenna but very little energy is coupled to the receiver port, and vice versa. The duplexer is constructed to have a high frequency side and low frequency side (both frequencies within the 60 GHz, band with about 2 GHz channel bandwidths). In an example, at one end of the link (“terminal A”), the transmitter waveguide module is coupled to the high frequency port, and the receiver module is coupled to the low frequency port (i.e. “transmit high”). At the other end of the link (“terminal B”) the receiver module is coupled to the high frequency port and the transmitter module is coupled to the low frequency port (“transmit low”). In this way a link functions as a full-duplex system using single antennas at each end which commonly are coupled to the respective transmitter and receiver modules.

The waveguide module is configured to provide highly efficient millimeter wave energy transfer. Details of the waveguide module are found in co-pending U.S. patent application Ser. No. 13/383,203, Filed Jan. 19, 2012 and entitled, “Precision Waveguide Interface.”

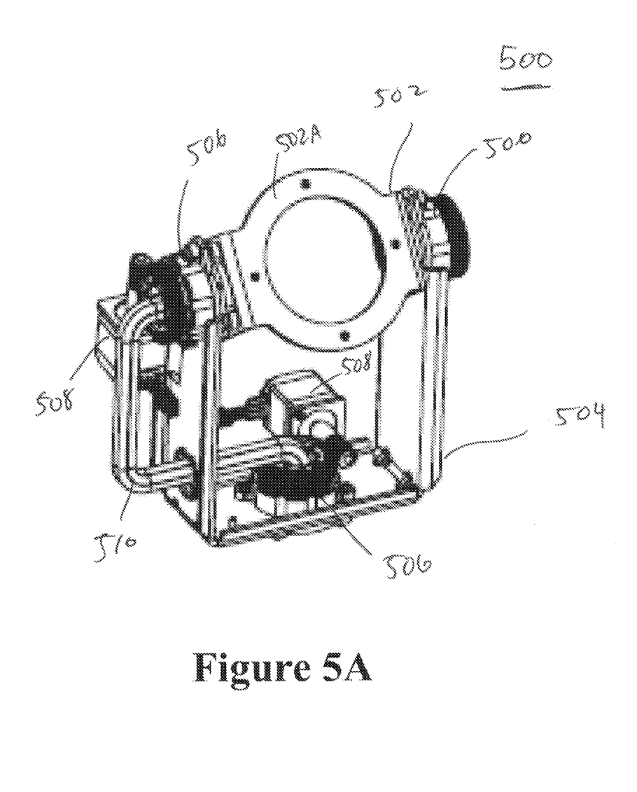

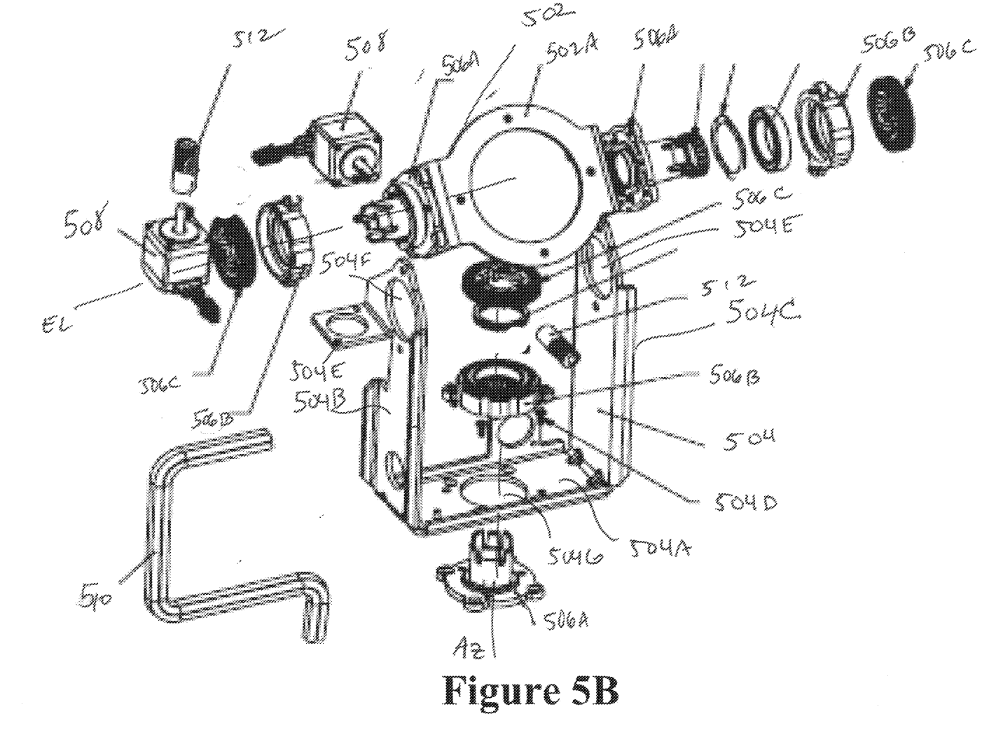

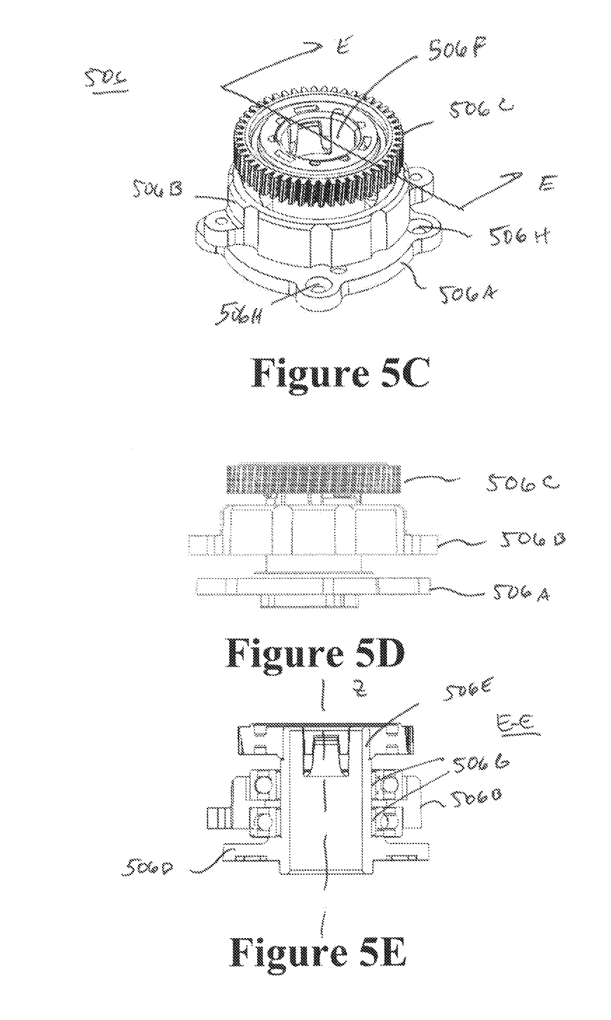

FIG. 5A illustrates a non exploded view and FIG. 5B illustrates an exploded view of the gimbal assembly 500 in accordance with an aspect of the present disclosure. As shown in FIGS. 5A and 5B, the gimbal assembly 500 includes an antenna bracket 502 coupled to a U-shaped bearing housing 504 via one or more side gear assemblies 506 powered by motors 508.

As shown in FIG. 5B, the bearing housing 504 includes a horizontal bottom bar 504A and two vertically extending upright bars 504B, 504C. In addition, the bearing housing 504 includes a motor housing bracket 504D on the bottom bar 504A and a motor housing bracket 504E on the either/both of the upright bars 504B, 504C. Motors 508 are coupled to the gear assemblies 506 at the brackets 504D and 504E. Each upright bar includes an aperture 504E and 504F configured to allow coupling of the antenna bracket 502 with the bearing housing 504 via gear assemblies 506. In addition, the bottom bar 504A includes an aperture 504G configured to receive gear assembly 506.

The gear assemblies 506, as shown in FIGS. 5C-5E, include a gear base 506A, a freely rotatable intermediate gear housing 506B and a helical gear 506C. As shown in FIG. 5D, the gear base 506A has a flanged area 506D and a vertically extending core 506E. The flanged area 506D includes securing means 506H for mounting the gear assembly to the gimbal assembly 500. As stated above, the gear assembly 506 is designed to be coupled to either the base 306 (FIG. 3C) or the antenna assembly 502 (FIG. 5B). The core 506E of the base 506A extends vertically from the flange 506D along axis Z and has a hollow channel 506F which runs in communication with apertures in the helical gear 506C and the flange 506D. The hollow channel 506F allows a cable 510 to run through the gear assemblies 506 from outside the terminal 100 to the electronics and mechanical components inside the terminal 100.

As shown in FIG. 5E the helical gear 506C is mounted to the core 506E at the end opposite of the flange 506D. By being mounted to the core 506E, rotational movement of the helical gear (about axis Z) causes corresponding rotational movement of the flange 506D. Intermediate gear housing 506B is coupled to the core 506E by virtue of bearings and is configured to freely rotate about axis Z irrespective of the helical gear 506C or flange 506D. In other words, the intermediate gear housing 506D does not rotate along with the helical gear 506C or flange 506D, but is substantially stationary rotation-wise.

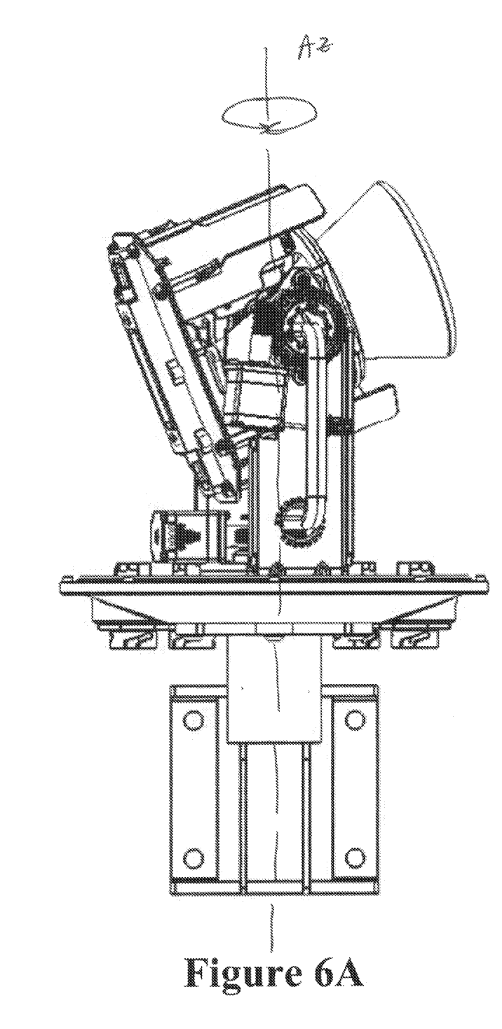

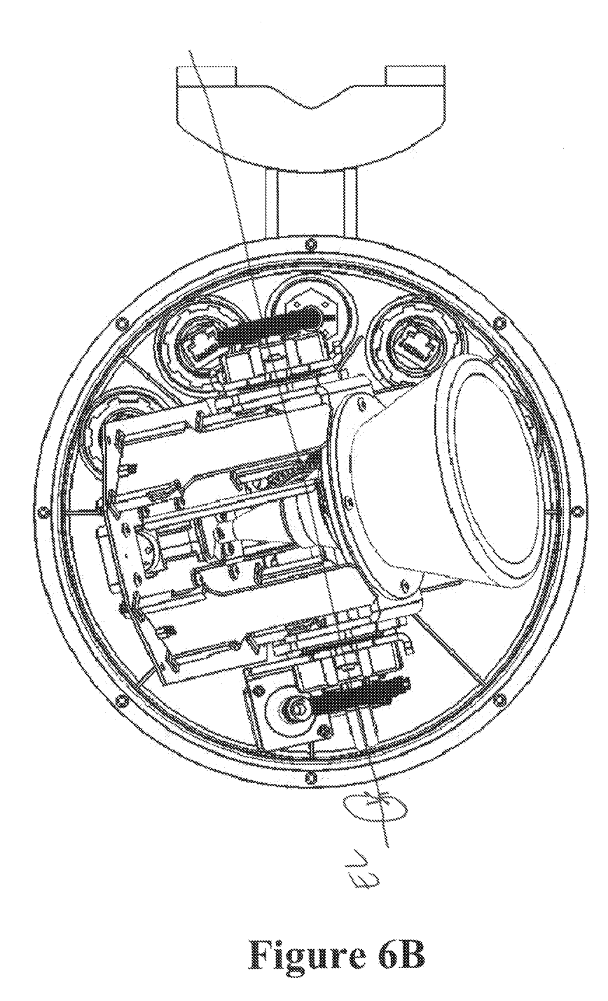

As shown in FIG. 3C, the antenna assembly 400 couples to the gimbal assembly 500 to form a single unit. In particular, the flanged portion 402C of the horn antenna 402 (FIG. 4) mounts to the ring portion of the 502A of the antenna bracket 502 when the antenna assembly is coupled to the gimbal assembly 500. As discussed in more detail below, the gimbal assembly 500 implements a mechanical assembly which allows the antenna assembly 400 to rotate 360 degrees or less about a horizontal, or elevational (EL) axis (FIGS. 3A, 3B, 6A, 6B). Additionally, the mechanical assembly allows the antenna assembly 400 rotate 360 degrees or less about a vertical or azimuth (AZ) axis (FIGS. 3A, 3B, 6A, 6B).

As shown in FIGS. 5A and 5B, one or more side oriented gear assemblies 506 are configured to couple the antenna bracket 502 with the bracket assembly 504. In particular, the flanges 506D of the gear base 506A are coupled to the sides of the antenna bracket 502. As shown in FIG. 5B, the gear bases 506A are coupled to the inside surface of upright bars 504B, 504C, wherein the core 506E extends through the apertures 504E, 504F. The intermediate gear 506B and the helical gear 506C are coupled to the core 506C and positioned on the outside surface of the upright bars 504B, 504C. Similarly, a bottom gear assembly is configured to couple the bracket assembly 504 to the terminal base 306. In particular, the gear base 506A is coupled to the bottom surface of the bottom bar 504A, wherein the core 504E of the bottom gear base 506A extends through the aperture 504G. The intermediate gear housing 506B and the helical gear 506C are coupled to the core 506E.

As shown in FIGS. 5A and 5B, a worm 512 is coupled to the motor 508 on one end, wherein the threaded portion of the worm 512 is coupled to the helical gear 506C of the gear assembly 506. In particular, operation of the motor 508 causes the worm to rotate and correspondingly cause the helical gear 506C to rotate. Rotation of the helical gear 506C, by virtue of being mounted to the core 506E, causes the gear base 506A to correspondingly rotate about its center axis.

In particular to the gimbal assembly shown in FIGS. 5A and 5B, motor 508 mounted to bracket 504E has a worm 512 in contact with a helical gear 506C of a gear assembly 506 coupled to the antenna bracket 502. Considering that the gear base 506A is mounted, via securing means 506H, to the antenna bracket 502, rotation of the gear base 506A will cause the antenna bracket to rotate about axis EL. This results in elevation rotational movement about the EL axis at the bearings of the side gear assemblies 506. In an aspect, the gear ratio between the worm 512 and the helical gear 506C is 50:1 to provide sufficient torque to move the mass of the antenna/PCB assembly about the EL axis.

Similarly, a motor 508 is coupled to the bracket 504D located at the bottom bar 504A of the bracket assembly 504. The motor 508 is mechanically coupled through worm 512 to the helical gear 506C that is coupled to the bottom bar 504A. Operation of this motor 508 causes the worm 512 to rotate about a center axis, wherein the threaded portion translates torque to the helical gear 506C, thereby resulting in azimuth rotational movement about the azimuth axis (AZ) at gear assembly 506.

As stated above, the positioning module 116, implemented as one or more circuits in the PCB 406, includes a multi-axis accelerometer, multi-axis gyroscope, a multi-axis compass and other like sensors. Whenever the antenna/gimbal assembly is moved in the EL or AZ directions, translational acceleration, rotational acceleration and magnetic compass heading changes are detected by the various sensors. Orientation of the HSHB and LSLB antennas 104, 108 relative to the horizon and to magnetic north can be calculated based on the data monitored by these sensors.

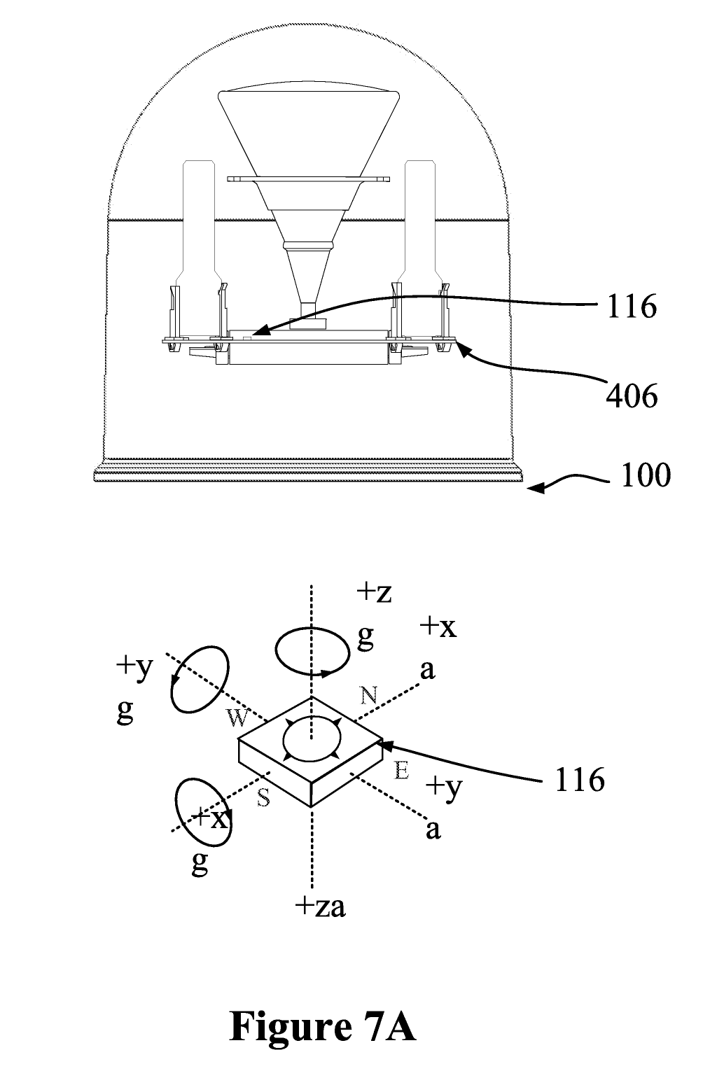

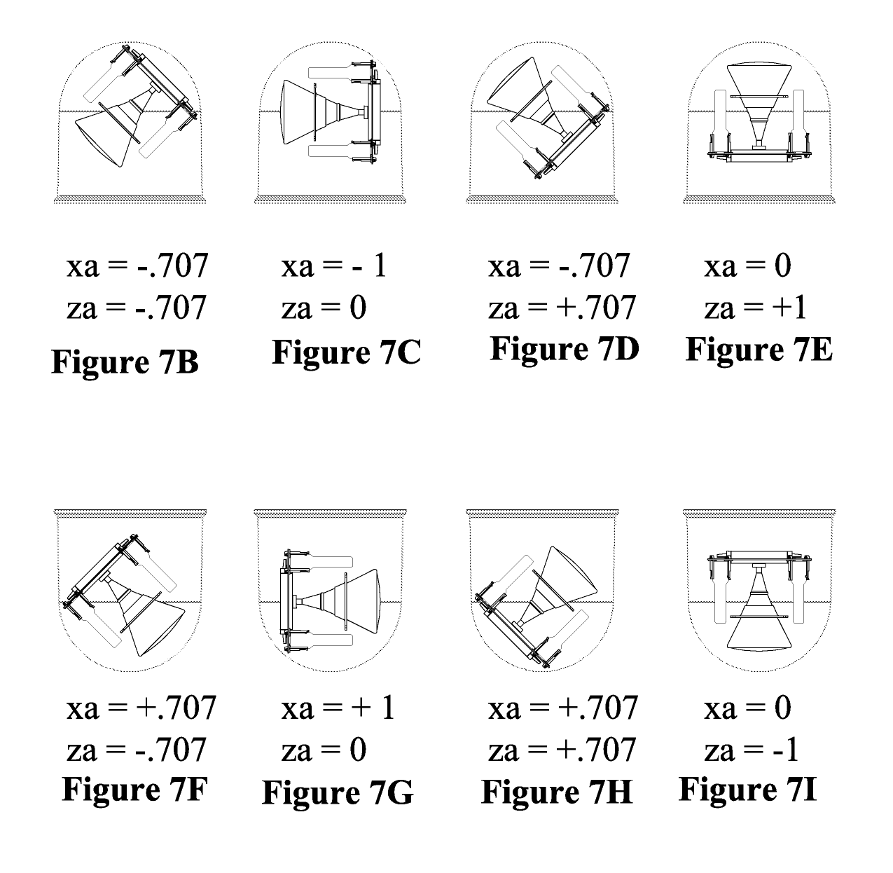

FIG. 7A shows the mounting location of the positioning module 116 on a printed circuit board 406 in accordance with an aspect of the present disclosure. In an aspect, the positioning module 116 includes a chip of including one or more of a multi-axis accelerometer, a multi-axis gyroscope, and a multi-axis magnetometer integrated therein. Reference numeral 116 shows the chip having multiple axis orientations in a perspective view. The positioning module 116 integrated circuit is mounted such that the x and y axes are coplanar and the z axes are orthogonal with printed circuit board 406. Any translational acceleration (x, y, z) is detected by the accelerometers, and any rotational acceleration (x, y, z) is detected by the gyroscopes. The multi-axis magnetometer is used to sense the earth's magnetic field and thus provide a magnetic compass function.

Terminal unit 300 can be mounted in either of two positions, upright or inverted (FIGS. 3A, 3B) providing the ability to have full omni-directional antenna pointing coverage range. Upon initialization, the control module 114 determines the orientation of the printed circuit board 406 relative to the horizon to calibrate the orientation of the gimbal/antenna assembly. In order to determine the orientation of the printed circuit board 406 relative to the horizon, the chip 116 analyzes the x and z accelerometer axes. FIGS. 7B through 7I show example printed circuit board 406 orientations with associated x and z axes accelerometer output indications. Control module 114 monitors the positioning module 116 output indications. Note that FIGS. 7B through 7E show printed circuit board 406 in example orientations when terminal unit 300 is mounted in the upright position. Note that FIGS. 7F through 7I show printed circuit board 406 in example orientations when terminal unit 300 is mounted in the inverted position.

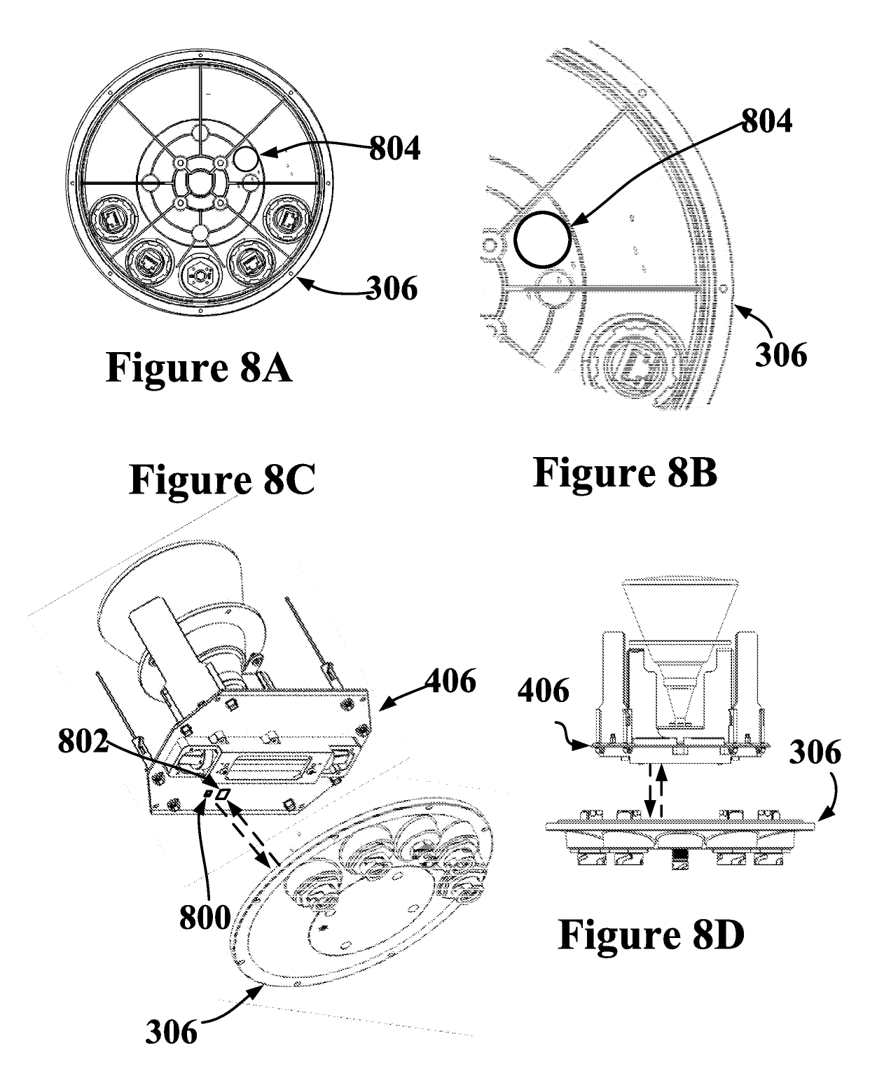

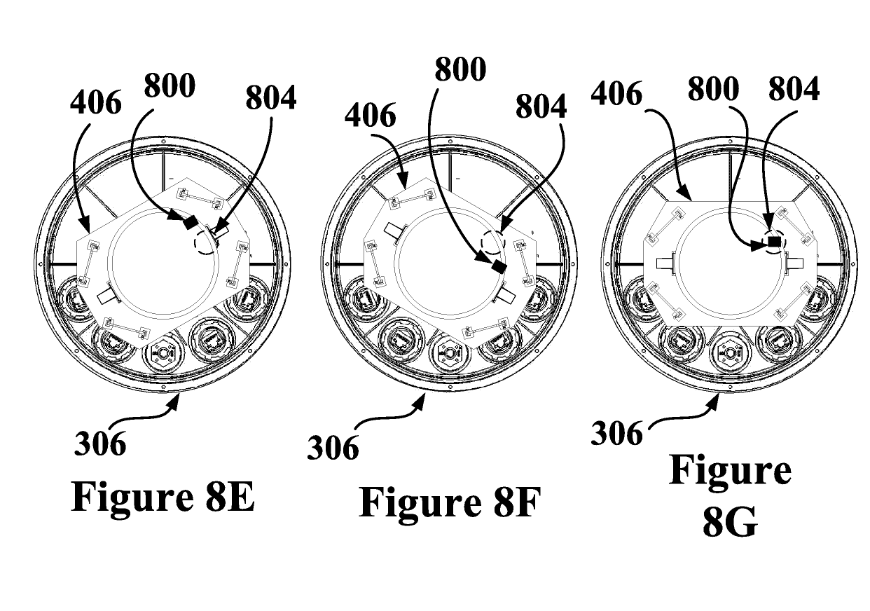

FIGS. 8A through 8D illustrate an optical alignment system implemented in the terminal in accordance with an aspect of the present disclosure. As shown in FIGS. 8A-8D, the optical alignment system is composed of an optical infrared (IR) emitter 800 with infrared detector 802 which are both mounted to printed circuit board 406. The IR emitter 800 emits an emission of IR pulses controlled from detector integrated circuit 802. If there is sufficient reflected IR energy coming back to detector 802, detector 802 will provide a positive detection signal to control module 114. In an aspect, the terminal includes a patch 804 which is made of highly IR reflective material that is located to the internal surface of terminal base plate 306. When the printed circuit board 406 is horizontal and oriented such that the IR emitter 800 and detector 802 are oriented over base plate 306 and the reflective patch 804 is directly below the IR emitter 800 and detector 802, a positive detection will be signaled to the control module 114 as shown in FIGS. 8C, 8D and 8G. This position is named the “home” position for the printed circuit board 406.

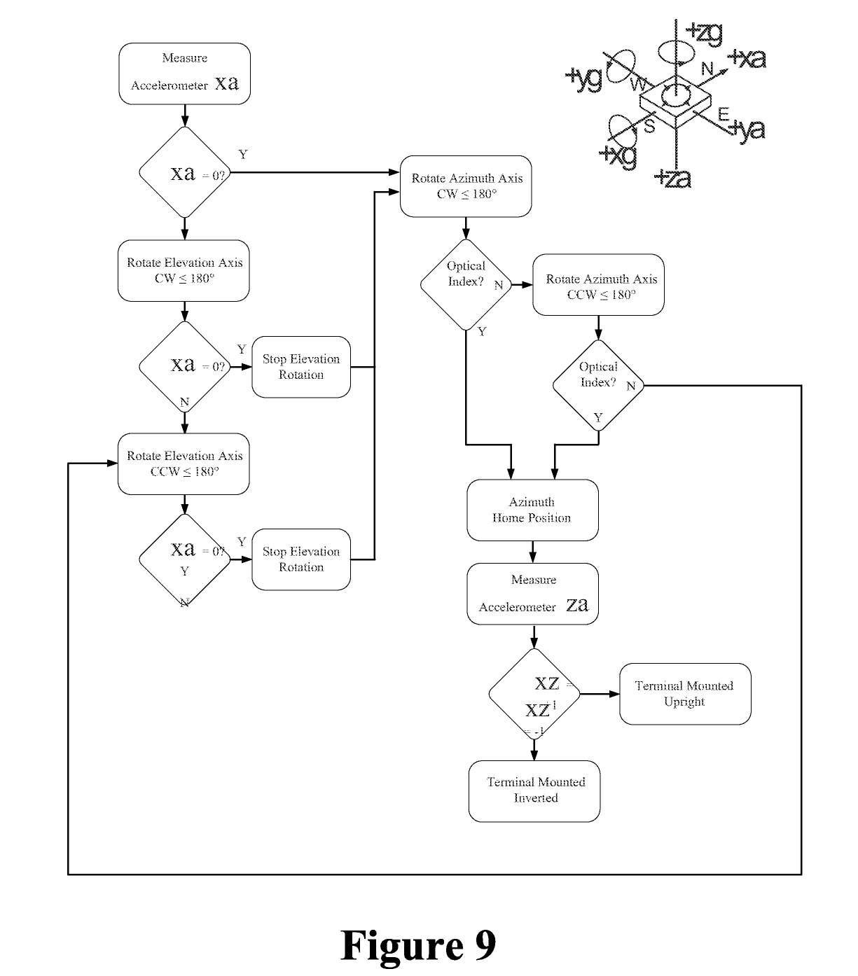

FIG. 9 illustrates a flow chart representing the initial calibration process performed by the terminal in accordance with an aspect of the present disclosure. In particular, FIG. 9 illustrates the method used by the terminal 100 to detect the orientation of the printed circuit board 406 orientation relative to the horizon when terminal is mounted in either the upright or inverted position. The x-axis of the accelerometer on positioning module 116 is oriented such that changes in the elevation angle of the printed circuit board 406 provides output indications as shown in FIGS. 7B through 7I. As shown, when the x-axis output indication is zero, the printed circuit board 406 is in the horizontal position relative to the horizon. The horizon position is defined as that which is orthogonal to the gravity vector which affects the accelerometer output indications. For example, when the printed circuit board 406 is oriented vertically (orthogonal to the horizon), the x-axis accelerometer output indication will be either +1 or −1. For angles between the horizon and orthogonal the x-axis output will vary between zero and +/−1. The z-axis accelerometer portion of positioning module 116 will indicate either +1 or −1 when the printed circuit board 406 is oriented to the horizon caused by the acceleration due to gravity when in this position.

As shown in FIG. 9, the x-axis accelerometer is measured for output indication. If the x-axis is at zero (xa=0? Y), then the printed circuit board 406 is oriented to the horizon and the next step is to establish the home position in the azimuth axis and determine whether terminal unit 300 is mounted upright or inverted. This is done by rotating the antenna/gimbal assembly clockwise (CW) about the azimuth (AZ) axis up through 180 degrees while monitoring the optical IR detector. If the optical detector provides positive output indication (Optical Index?=Y), then it is determined that the printed circuit board 406 is in the home position. Once the home position is found, the z-axis accelerometer is measured by the control module 114. If the z-axis accelerometer is determined to be equal to +1, the terminal unit 100/300 is mounted in the upright position, the if z-axis accelerometer is determined to be equal to −1, the terminal unit 300 is mounted in the inverted position.

If the x-axis is not at zero when initially measured, then the elevation axis is first rotated clockwise up through 180 degrees. In contrast, if the x-axis is not found to be zero through this range, it is then rotated counter clockwise through 180 degrees relative to the starting position. These actions are indicated in the flow chart of FIG. 9, with each case tested for x-axis accelerometer reaching zero (xa=0? Y/N). Once the x-axis achieves zero, and if the azimuth axis does not get positive optical detection from the initial CW rotation, then the azimuth axis is reversed and CCW rotation is initiated in order to find the home position. Note that if the azimuth axis cannot achieve optical detection when trying both CW and CCW rotation, (second Optical Index?=N), then the algorithm reverts to changing the orientation of printed circuit board 406 on the elevation axis. This will happen if printed circuit board 406 is not oriented with the optical detector facing the base plate 306, and by rotating printed circuit board 406 back through the elevation axis will re-orient printed circuit board 406 such that optical detector is facing the base plate 306 in order to achieve home position.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A wireless backhaul system including a terminal comprising:
a network interface configured to send and receive data over a wide area network;
a control module coupled to the network interface and configured to generate electromagnetic energy;
an antenna assembly coupled to the control module and the network interface, the antenna assembly including a high speed-high bandwidth (HSHB) antenna configured to wirelessly emit millimeter wave electromagnetic energy signals to a target terminal;
a gimbal assembly coupled to the antenna assembly and the control module, the gimbal assembly configured to selectively position the antenna assembly to azimuth and elevation coordinates selected by the control module to establish and maintain a HSHB data communication link with the target terminal using the millimeter wave electromagnetic energy signals.

2. The system of claim 1, further comprising a target terminal, the target terminal comprising:
a network interface configured to send and receive data over the wide area network;
a control module coupled to the network interface and configured to generate electromagnetic energy;
an antenna assembly coupled to the control module and the network interface, the antenna assembly including a high speed-high bandwidth (HSHB) antenna configured to wirelessly emit millimeter wave electromagnetic energy signals to the terminal;
a gimbal assembly coupled to the antenna assembly and the control module, the gimbal assembly configured to selectively position the antenna assembly to azimuth and elevation coordinates selected by the control module to establish and maintain a HSHB data communication link with the terminal using the millimeter wave electromagnetic energy signals.

3. The system of claim 1, further comprising:
a base configured to receive the gimbal assembly;
a radome lid coupled to the base and configured to form an enclosure between the radome lid and the base, wherein the gimbal and antenna assemblies are positioned within the enclosure.

4. The system of claim 1, wherein the terminal is configured to be secured to a fixture.

5. The system of claim 1, wherein the gimbal assembly further comprises:
an antenna bracket configured to couple with the antenna assembly;
a U-shaped bracket mount coupled to the antenna bracket and a base of a terminal housing:
a first gear assembly coupled to antenna bracket and the bracket mount, the first gear assembly configured to allow rotation of the antenna bracket along an elevation axis; and
a second gear assembly coupled to the bracket mount, the second gear assembly configured to allow rotation of the gimbal assembly in an azimuth axis.
